(19) United States
(12) Patent Application Publication
(10) Pub. No.: US 2006/0079606 A1
(43) Pub. Date: Apr. 13, 2006

(54) Low dielectric constant substrate

(75) Inventors: Chun-Kuo Min, Hsinchu (TW); Hsi-Hsin Shih, Taichung City (TW); Mao-Feng Hsu, Taipei City (TW); Hsin-Hung Yao, Taichung City (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/165,127

(22) Filed: Jun. 24, 2005

(30) Foreign Application Priority Data
Oct. 8, 2004 (TW) 93130510

(51) Int. Cl. C01B 33/12; C08K 9/06

(52) U.S. Cl. 523/212; 423/335

(57) ABSTRACT

A mesoporous silica powder. The powder comprises an open pore structure, generates a diffractive peak when irradiated by an X-ray with an incident angle of less than about 10 degrees.

### BACKGROUND

The invention relates to a low dielectric constant substrate and in particular to a low dielectric constant substrate with a mesoporous silica powder.

To obtain a high frequency and high-speed device, a low dielectric constant substrate is needed. Epoxy resin and polyimide resin are popular substrate materials particular, resin substrates having dielectric constants of about 4.5˜3.2 in 1 MHz. However, this dielectric constant is not low enough for high frequency and high-speed device.

European Patent No. 382,312 and U.S. Pat. No. 6,569,982 disclosed other resin materials to decrease dielectric constant. For example, using bismaleimide resin as a substitute for epoxy resin can decrease dielectric constant by 1 MHz. The water absorbing capacity and costs increase, however, which reduces device performance and production.

U.S. Pat. No. 5,670,250 and Japan Patent No. 2002100238 further disclosed that a decrease in substrate dielectric constant was achieved by adding a porous inorganic powder to resin. The powder is zeolite or ceramic. The average pore size of zeolite and ceramic is smaller than about 2 nm, however, which limits dielectric constant reduction. A pore of this type of powder is closed, which easily burst at higher temperature, thus this powder is not stable enough during heat treatment. The inorganic powder is hard to mix well with resin, thus this powder has a precipitation problem.

### SUMMARY

Accordingly, embodiments of the invention provide a low dielectric constant substrate.

In one embodiment, a mesoporous silica powder is disclosed. This powder comprises an open pore structure, and generates a diffractive peak when irradiated by an X-ray with an incident angle of less than about 10 degrees.

In another embodiment, a low dielectric constant epoxy resin precursor solution is disclosed. This solution comprises, based on the total weight of the precursor solution, about 60˜80 wt % of an epoxy resin, about 1-20 wt % of a mesoporous silica powder, about 0.001˜1 wt % of a catalyst, about 1˜5 wt % of a curing agent, and about 10˜30 wt % of a solvent.

In another embodiment, a low dielectric constant polyimide resin precursor solution is disclosed. This solution comprises, based on the total weight of the precursor solution, about 60˜80 wt % of a polyimide resin precursor, about 10-30 wt % of a solvent, about 0.001˜1 wt % of a catalyst, and about 1-20 wt % of a mesoporous silica powder.

In another embodiment, a low dielectric constant substrate is disclosed. This substrate comprises a resin, and a mesoporous silica powder dispersed in the resin having an open nanopore structure.

In another embodiment, a method for forming a low dielectric constant substrate is disclosed. A mesoporous silica powder precursor solution is provided. A mesoporous silica powder as a low dielectric constant substrate filler from the mesoporous silica powder precursor solution is formed. A varnish comprising a resin is added to the low dielectric constant substrate filler. A support is added to the varnish. The support is removed from the varnish and cured to form a low dielectric constant substrate.

### DESCRIPTION OF THE DRAWINGS

The embodiments can be more fully understood by reading the subsequent detailed description and Examples with references made to the accompanying drawings, wherein:

FIG. 1 is three XRD diagrams of mesoporous silica powders of Example 1.

FIG. 2 is a perspective drawing of a hexahedron mesoporous silica powder.

### DETAILED DESCRIPTION

Mesoporous Silica Powder Synthesis

The synthesis of mesoporous silica powders will be disclosed. As used herein, the term “mesoporous” means pore sizes of about 2˜50 nm.

The mesoporous silica powder can be formed by a sol-gel reaction. A mesoporous silica powder precursor solution is provided. This solution comprises a Si-containing compound, a pore-forming agent, a catalyst, an organic solvent and pure water. The pore-forming agent is bonded between the Si-containing compounds to form a gel by stirring. After stirring, standing, filtrating, washing with pure water, drying and calcining, the mesoporous silica powder is obtained.

The Si-containing compound is used as the mesoporous silica powder precursor, such as tetramethfyammonium hydroxide, tetraethyl orthosilicate (TEOS), sodium silicate or combination thereof, preferably tetraethyl orthosilicate (TEOS).

The pore forming agent may be a surfactant, such as cethyltrimethylammonium chloride (CTACL), cethyltrimethylammonium bromide, poly(ethylene glycol)₂₀-block-poly(propylene glycol)₇₀-block-poly(ethylene glycol)₂₀ or poly(ethylene glycol)₁₀₆-block-poly(propylene glycol)₇₀-block-poly(ethylene glycol)₁₀₆.

The catalyst comprises HCl, NH₄OH or NaOH. The organic solvent comprises ethanol, propanol or iso-propanol.

Based on the total weight of the Si-containing compound, the pore-forming agent, a catalyst, an organic solvent and pure water have amounts of about 0.05˜0.6 wt %, about 0.2˜75 wt %, about 40˜160 wt % and about 20˜1900 wt % repectively.

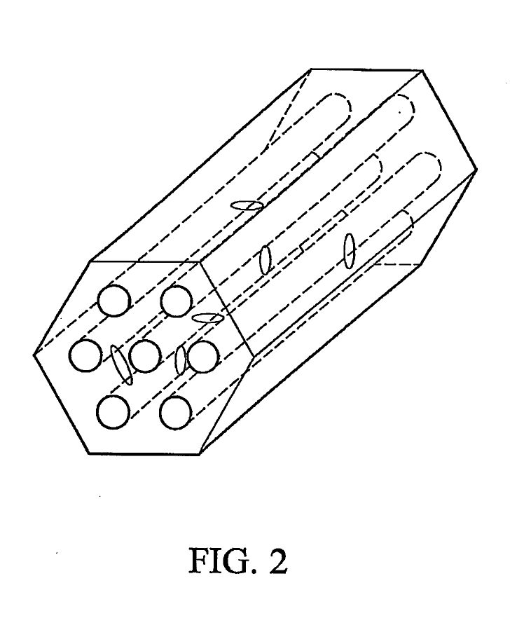

The mesoporous silica powder is a hexahedron, as shown in FIG. 2, or cubic, and has a diameter of about 0.01˜10 μm. The mesoporous silica powder has a specific surface area of about 100˜1500 m²/g, thus it more easily mixes with resin.

The mesoporous silica powder comprises a plurality of regularly arranged open tubular pores therein, thus this powder is more stable during heat treatment than closed pore powder. The tubular pore is cylinder or curved.

The pore size is more than 2 nm, such as 2˜20 nm, preferably 2˜5 nm, and the pore has an aspect ratio of about 500˜1500, thus the powder has a lower dielectric constant than conventional powder.

The mesoporous silica powder generates a diffractive peak when irradiated by an X-ray with an incident angle of less than about 10 degree.

Mesoporous Silica Powder Modification

In accordance with the invention, the mesoporous silica powder is modified to solve powder precipitation problems.

The mesoporous silica powder is added to a silane coupling agent and a solvent. The silane coupling agent may use methyltrimethoxysilane (MTMS), propyltrimethoxysilane (PTMS), phenyltrimethoxysilane (PhTMS), octyltriethoxysiliane (OTES) or 3-aminopropyl-trimethoxysilane, preferably 3-aminopropyl-trimethoxysilane. The solvent comprises toluene or acetone. This solution is heated to 100˜200° C. in oil bath under inert gas, such as N₂. After reflux for 1˜5 hours, the solution is cooled to room temperature, and the powder is removed from the solution by a vacuum filter. After washing with solvent and drying in an oven at 50˜150° C. for 1˜5 hours, the modified mesoporous silica powder is obtained, and its surface has a terminal group, such as amino group. This terminal increases powder lipophile, thus the dispersion of the powder in resin increases.

Low Dielectric Constant Epoxy Resin Fabrication

A low dielectric constant epoxy resin precursor solution is prepared and is proceeded a cross-linking reaction at high temperature to obtain a low dielectric constant epoxy resin.

This epoxy resin precursor solution comprises an epoxy resin, the mesoporous silica powder, a catalyst, a curing agent and a solvent. The catalyst, the curing agent and the solvent may be 2-methyl-imidazole, dicyandiamide and dimethyl foramide respectively. Based on the total weight of the precursor solution, the amounts of the epoxy resin, the mesoporous silica powder, the catalyst, the curing agent and the solvent are about 60˜80 wt %, about 1-20 wt %, about 0.001˜1 wt %, about 1˜5 wt % and about 10˜30 wt % respectively.

Low Dielectric Constant Polyimide Resin Fabrication

A low dielectric constant polyimide resin precursor solution is prepared and dehydration and cyclization at 80˜300° C. proceed to obtain a low dielectric constant polyimide resin.

This polyimide resin precursor solution comprises a polyimide resin precursor, a solvent, a catalyst and the mesoporous silica powder. Based on the total weight of the precursor solution, the polyimide resin precursor comprises about 60˜80 wt % of 2,2-bis(4-[aminophenoxy]phenyl)propane and about 1˜5 wt % of oxydiphthalic anhydride. The amounts of solvent, the catalyst and the mesoporous silica powder are about 10-30 wt %, about 0.001˜1 wt % and about 1-20 wt % respectively. The solvent comprises N,N-dimethhyl-acetamide.

Low Dielectric Constant Substrate Fabrication

In this embodiment, a method for forming a low dielectric constant substrate is disclosed.

The resin comprising the modified mesoporous silica powder and a support are added into a varnish. The support is taken out from the varnish and is cured to form a low dielectric constant substrate.

The support comprises, but is not limited to, a glass fiber or a copper foil. The resin is an epoxy resin or a polyimide resin. When the resin is epoxy resin, the substrate has a dielectric constant of about 2.9˜3.3 at 1 MHz. When the resin is polyimide resin, the substrate has a dielectric constant of about 2.0˜3.0 at 1 MHz. This substrate is more suitable for high frequency devices than a conventional substrate.

### EXAMPLE 1

### Mesoporous Silica Powder Synthesis

2.7 g Na₂SiO₃, 4.69 g tetramethyammonium hydroxide and 27.42 g pure water were put in a beaker and stirred. 16.46 g cetyltrimethylammonium chloride (CTACL) was added and stirred 3 hours. 1M H₂SO₄ with a pH of about 11 was slowly dripped. After standing for 24 hours, the powder in the solution precipitated. After stirring, the solution was poured in a high press autoclave and dried in an oven 150° C. for 48 hours. The precipitated solid was filtered and washed by 2 L pure water. The solid was dried at 100° C. for 48 hours and calcined at 550° C. for 6 hours to obtain 1˜2.5 g white mesoporous silica powder.

Different structures and specific surface area mesiporous silica powders were obtained by the above method but different materials and amounts were used, as shown in Table 1.

TABLE 1
Different Samples of Example 1

| | | | | Specific | |
|---|---|---|---|---|---|
| | SiO₂:CTACL | Na₂SiO₃ | | surface | Pore |
| | mole | added | XRD | area | size |
| Sample No. | ratio | times | intensity | (m²/g) | (nm) |
| 1-1 | 4:1 | Twice | 22000 | 808 | 3.81 |
| 1-2 | 4:1 | Once | 19000 | 633 | 3.89 |
| 1-3 | 6:1 | Once | 9000 | 551 | 3.88 |

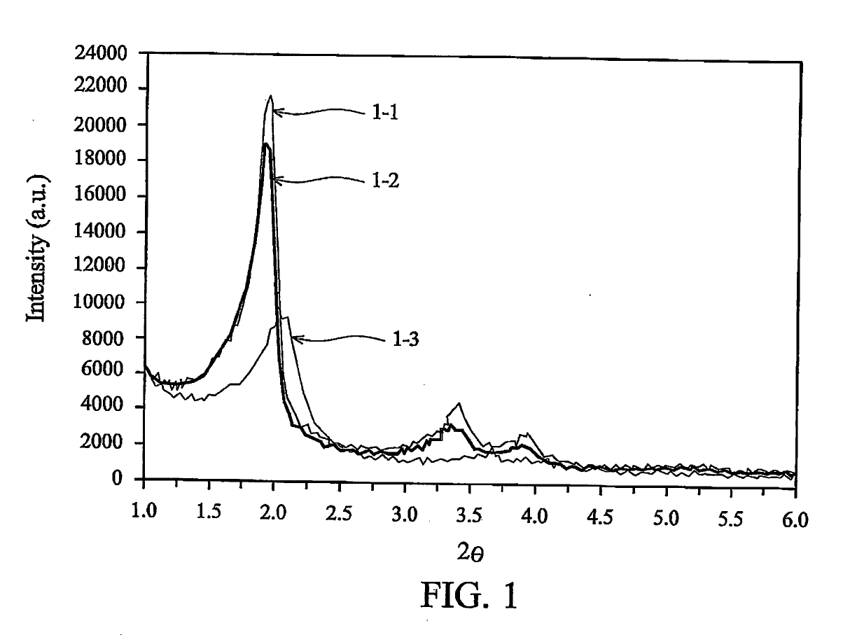

FIG. 1 is a XRD diagram of sample 1-1, 1-2 and 1-3. It shows that the mesopore of the three samples are regularly arranged, especially the sample 1-1. This means the sample 1-1 has the largest specific surface area.

The three samples were formed in use of surfactant CACL, thus the pore sizes are about 3.8 nm.

### EXAMPLE 2

### Mesoporous Silica Powder Synthesis

150 ml 1M H₂SO₄ was added in 75 ml deioned water to form a H₂SO₄ solution. 2.4 g poly(ethylene glycol)₂₀-block-poly(propylene glycol)₇₀-block-poly (ethylene glycol)₂₀ (P123) was added and stirred until P123 dissolved. 8.85 g tetraethyl orthosilicate (TEOS) was added and stirred at 35° C. for 20 hours and stirred at 90° C. for 24 hours. A solid was obtained from the solution by filtering, and was washed with pure water several times. The solid was dried at 100° C. and calcined at 550° C. for 6 hours to obtain 1˜2.5 g white mesoporous silica powder.

Table 2. shows different lattice constants, diffractive intensities, specific surface areas and pore sizes cause by different TEOS to P123 rations.

TABLE 2
Different Samples of Example 2

| | | | | Specific | |
|---|---|---|---|---|---|
| | TEOS to | Lattice | | Surface | Pore |
| Sample | P123 weight | constant | XRD | area | size |
| No. | ratio | (angstrom) | intensity | (m²/g) | (nm) |
| 2-1 | 2.19 | 98 | 14333 | 1055 | 55 |
| 2-2 | 4.36 | 94 | 18206 | 779 | 43 |
| 2-3 | 3.68 | 90 | 4623 | 555 | 47 |

### EXAMPLE 3

### Mesoporous Silica Powder Modification

1 g mesoporous silica powder and 6 g 3-aminopropyl-trimethoxysilane were added to 50 ml toluene. This solution was refluxed in oil bath at 100° C. in N₂.

After refluxing for 24 hours, the solution was cooled to room temperature. A solid was obtained by filtering, and was washed wiht toluene or acetone several times. The solid was dried at 100° C. for 2 hours to obtain 1.2˜1.5 g modified mesoporous silica powder with amino functional group.

Table 3 shows carbon, hydrogen and nitrogen amounts of modified and non-modified mesoporous silica surface by element analysis. After modification, the carbon, hydrogen and nitrogen amounts increase.

TABLE 3
Mesoporous Silica Surface Element Aanlysis of Example 3

| Sample/element | | | |
|---|---|---|---|
| amout | C(%) | H(%) | N(%) |
| Before modify | 0 | 0 | 0 |
| After modify | 2.504 | 1.127 | 1 |

### EXAMPLE 4

### Low Dielectric Constant Epoxy Resin Fabrication

0.73 g curing agent (dicyandiamide) and 0.0037 g catalyst (2-methyl-imidazoleride) were dissolved in 5.8 g dimethyl foramide solvent. 2 g modified mesoporous silica powder and 20 g epoxy resin were added and stirred for 1 hour. This solution was put in an oven to proceed cross-linkage reaction to obtain 22 g low dielectric constant epoxy resin.

Table 4 shows the dielectric constant of pure epoxy resin and epoxy resin/modified mesoporous silica in 1 MHZ, 50 MHz, 100 MHz, 500 MHz and 1 GHz. The epoxy resin with added modified mesoporous silica has lower dielectric constant in different frequency.

TABLE 4
Dielectric Constants of Different Resins

| Resin/Frequency | 1 MHz | 50 MHz | 100 MHz | 500 MHz | 1 GHz |
|---|---|---|---|---|---|
| Pure epoxy | 4.11 | 3.64 | 3.57 | 3.42 | 3.35 |
| resin | | | | | |
| Epoxy | 3.29 | 3.11 | 3.05 | 2.97 | 2.92 |
| resin/modified | | | | | |
| mesoporous | | | | | |
| silica | | | | | |

### EXAMPLE 5

### Low Dielectric Constant Polyimide Resin Fabrication

Polyimide resin precursor, 0.9779 g 2,2-bis(4-[aminophenoxy]phenyl)propane, was dissolved in 9.7 ml N,N-dimethhyl-acetamide solvent. 0.0515 g modified mesoporous silica powder was added and stirred for 3 hours. This solution was put in an oven at 80° C. for 30 min, 150° C. for 6 hours, 200° C. for 6 hours, 250° C. for 2 hours and 300° C. for 5 hours, to proceed dehydration and cyclization reaction to obtain 1.772 g low dielectric constant polyimide resin.

Table 5 shows the dielectric constants of pure Polyimide resin and polyimide resin/modified mesoporous silica in 1 MHZ, 50 MHz, 100 MHz, 500 MHz and 1 GHz. The polyimide resin adding with modified mesoporous silica has lower dielectric constant in different frequency.

TABLE 5
Dielectric Constants of Different Resins

| Resin/Frequency | 1 MHz | 50 MHz | 100 MHz | 500 MHz | 1 GHz |
|---|---|---|---|---|---|
| Pure polyimide | 3.32 | 3.31 | 3.28 | 3.03 | 2.50 |
| resin | | | | | |
| Polyimide | 2.65 | 2.53 | 2.50 | 2.45 | 2.45 |
| resin/modified | | | | | |
| mesoporous | | | | | |
| silica | | | | | |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mesoporous silica powder, the mesoporous silica powder comprises an open pore structure, and generates a diffractive peak when irradiated by an X-ray with an incident angle of less than about 10 degrees.

2. The mesoporous silica powder as claimed in claim 1, wherein the mesoporous silica powder is a hexahedron or cubic with a plurality of regularly arranged open tubular pores therein.

3. The mesoporous silica powder as claimed in claim 2, wherein the tubular pore is cylinder or curved.

4. The mesoporous silica powder as claimed in claim 1, further comprising a surface modified by a silane coupling agent.

5. The mesoporous silica powder as claimed in claim 1, wherein the mesoporous silica powder has a diameter of about 0.0˜10 μm.

6. The mesoporous silica powder as claimed in claim 1, wherein the mesoporous silica powder has a specific surface area of about 100˜1500 m²/g.

7. The mesoporous silica powder as claimed in claim 4, wherein a surface of the modified mesoporous silica powder has a terminal amino group.

8. The mesoporous silica powder as claimed in claim 7, wherein the terminal amino group is the aminopropyl group.

9. The mesoporous silica powder as claimed in claim 2, wherein the open tubular pore has an aspect ratio of about 500˜1500.

10. The mesoporous silica powder as claimed in claim 1, wherein the mesoporous has a diameter of about 2˜20 nm.

11. The mesoporous silica powder as claimed in claim 4, wherein the silane coupling agent is methyltrimethoxysilane (MTMS), propyltrimethoxysilane (PTMS), phenyltrimethoxysilane (PhTMS), octyltriethoxysiliane (OTES), or 3-aminopropyl-trimethoxysilane.

12. A low dielectric constant epoxy resin precursor solution, comprising, based on the total weight of the precursor solution:
about 60˜80 wt % of an epoxy resin;
about 1-20 wt % of a mesoporous silica powder;
about 0.001˜1 wt % of a catalyst;
about 1˜5 wt % of a curing agent; and
about 10˜30 wt % of a solvent.

13. The low dielectric constant epoxy resin precursor solution as claimed in claim 12, wherein the mesoporous silica powder is a hexahedron or cubic with a plurality of regularly arranged open tubular pores therein.

14. The low dielectric constant epoxy resin precursor solution as claimed in claim 12, wherein the mesoporous silica powder has an open pore structure, and generates a diffractive peak when irradiated by an X-ray with an incident angle of less than about 10 degree.

15. A low dielectric constant polyimide resin precursor solution, comprising, based on the total weight of the precursor solution:
about 60˜80 wt % of a polyimide resin precursor;
about 10-30 wt % of a solvent;
about 0.001˜1 wt % of a catalyst; and
about 1-20 wt % of a mesoporous silica powder.

16. The low dielectric constant polyimide resin precursor solution as claimed in claim 15, wherein the mesoporous silica powder is a hexahedron or cubic, and a plurality of regularly arranged open tubular pores therein.

17. The low dielectric constant polyimide resin precursor solution as claimed in claim 15, wherein the mesoporous silica powder has an open pore structure, and generates a diffractive peak when irradiated by an X-ray with an incident angle of less than about 10 degrees.

18. The low dielectric constant polyimide resin precursor solution as claimed in claim 15, wherein the polyimide resin precursor comprises about 60˜80 wt % of 2,2-bis(4-[aminophenoxy]phenyl)propane and about 1˜5 wt % of oxydiphthalic anhydride.

19. A low dielectric constant substrate, comprising:
a resin; and
a mesoporous silica powder dispersed in the resin having an open nanopore structure.

20. The low dielectric constant substrate as claimed in claim 19, further comprising a support.

21. The low dielectric constant substrate as claimed in claim 19, wherein the mesoporous silica powder comprises an open pore structure, and generates a diffractive peak when irradiated by an X-ray with an incident angle of less than about 10 degrees.

22. The low dielectric constant substrate as claimed in claim 20, wherein the support is a glass fiber.

23. The low dielectric constant substrate as claimed in claim 19, wherein the resin is an epoxy resin, and the low dielectric constant substrate has a dielectric constant of about 2.9˜3.3 at 1 MHz.

24. The low dielectric constant substrate as claimed in claim 19, wherein the resin is a polyimide resin, and the low dielectric constant substrate has a dielectric constant of about 2.0˜3.0 at 1 MHz.

25. A method for forming a low dielectric constant substrate, comprising:
providing a mesoporous silica powder precursor solution;
forming a mesoporous silica powder as a low dielectric constant substrate filler from the mesoporous silica powder precursor solution;
adding a varnish comprising a resin to the low dielectric constant substrate filler;
adding a support to the varnish; and
removing the support from the varnish and curing the support to form a low dielectric constant substrate.

26. The method as claimed in claim 25, further comprising modifying the mesoporous silica powder by a silane coupling agent.

27. The method as claimed in claim 25, wherein the mesoporous silica powder is formed from the mesoporous silica powder precursor solution by steps of stirring, standing, filtrating, washing with pure water, drying and calcining.

28. The method as claimed in claim 25, wherein the support is a glass fiber.

29. The method as claimed in claim 25, wherein the support is a copper foil.

30. The method as claimed in claim 25, wherein the mesoporous silica powder precursor solution comprising:
a Si-containing compound, based on the total weight of the Si-containing compound;
about 0.05˜0.6 wt % of a pore-forming agent;
about 0.2˜75 wt % of a catalyst;
about 40˜160 wt % of an organic solvent; and
about 20˜1900 wt % of a pure water.

31. The method as claimed in claim 30, wherein the Si-containing compound is tetramethyammonium hydroxide, tetraethyl orthosilicate (TEOS), sodium silicate, or combination thereof.

32. The low dielectric constant substrate forming method as claimed in claim 30, wherein the pore forming agent is a surfactant, comprising cethyltrimethylammonium chloride (CTACL), cethyltrimethylammonium bromide, poly(ethylene glycol)₂₀-block-poly(propylene glycol)₇₀-block-poly(ethylene glycol)₂₀, or poly(ethylene glycol)₁₀₆-block-poly(propylene glycol)₇₀-block-poly(ethylene glycol)₁₀₆.

33. The low dielectric constant substrate forming method as claimed in claim 30, wherein the catalyst is HCl, NH₄OH, or NaOH.

34. The low dielectric constant substrate forming method as claimed in claim 30, wherein the organic solvent is ethanol, propanol, or iso-propanol.

35. The low dielectric constant substrate forming method as claimed in claim 25, wherein the resin is an epoxy resin or a polyimide resin.

36. The low dielectric constant substrate forming method as claimed in claim 25, wherein the mesoporous silica powder comprises an open pore structure, and generates a diffractive peak when irradiated by an X-ray with an incident angle of less than about 10 degrees.
